(19) United States
(12) Patent Application Publication
(10) Pub. No.: US 2006/0235693 A1
(43) Pub. Date: Oct. 19, 2006

(54) High speed imaging system

(75) Inventors: Warren Ruderman, Demarest, NJ (US); Feruz Ganikhanov, Annandale, NJ (US)

Correspondence Address: STROOCK & STROOCK & LAVAN LLP, 180 MAIDEN LANE, NEW YORK, NY, 10038, US

(73) Assignee: INCRYS, INC.

(21) Appl. No.: 11/109,062

(22) Filed: Apr. 19, 2005

(51) Int. Cl. G10L 21/00

(52) U.S. Cl. 704/270

(57) ABSTRACT

A system for imaging high speed moving objects, for example, using a scanning beam and beam delivery optics with fast signal processing. It can allow for vocal fold imaging at up to or exceeding approximately 1000 frames per second with grayscale resolution as high as about 100 micrometers or higher and up to about a 12.4 mm square or larger viewing area. The invention can provide imaging of vocal fold vibration that correlates completely with a synchronously-acquired acoustic voice signal. This can enable physicians, voice therapists and research scientists to understand the consequences of abnormal laryngeal dynamics, rather than being limited to simply observing the dynamics. Further, the application of laser technology will allow for accurate measurements of dimension. This can objectify examination findings and treatment outcomes measurement, helping to overcome the serious limitations of current perceptual-based judgments.

### BACKGROUND OF INVENTION

The invention relates generally to a high speed imaging system and more particularly to an imaging system that can image objects moving at high speed in cramped quarters. Such a system can be useful for imaging the vocal cords and diagnosing abnormalities. The system can also be used to determine the precise position of the object whether it is stationary or moving.

Voice problems can cause significant social and occupational handicaps for individuals. They can be a symptom of serious, even life-threatening underlying disease. Visualization of vocal fold vibration can be essential for the treatment of individuals with many voice disorders.

Estimates of the prevalence of voice disorders range from 3% to 7% of the general population. See Colton R H, Casper J K, Understanding Voice Problems, 2nd Ed. Baltimore, Md., Williams and Wilkins; 1996; Healy, W C, Ackerman, B L, Chappell, C R, Perrin K L, Stormer, J, The Prevalence of Communicative Disorders, A Review of the Literature, Rockville, Md.: American Speech-Language-Hearing Association, 1981, the contents of which are incorporated herein by reference. Voice disorders have the potential to cause significant quality of life handicaps, See Benninger M S, Ahuja, A S, Gardner, G, Grywalski, C, Assessing outcomes for dysphonic patients, J Voice 1998, 12:540-550, the contents of which are incorporated herein by reference, and may represent serious or even life-threatening disease. See Simpson C B, Fleming D J. Medical and vocal history in the evaluation of dysphonia, In: Rosen C A, Murry T, eds, Otolaryngologic Clinics of North America Voice Disorders and Phonosurgery I 2000;33:719-729, the contents of which are incorporated herein by reference.

Laryngeal examination is essential for the diagnosis and treatment of voice disorders. See Rosen, C A, Murry, T., Diagnostic laryngeal endoscopy, I., Rosen C A, Murry T., eds. Otolaryngologic Clinics of North America Voice Disorders and Phonosurgery I 2000, 33:751-757, the contents of which are incorporated herein by reference. The weaknesses of current methods of laryngeal imaging are well recognized, See Rosen, C. A., Murry, T. Diagnostic laryngeal endoscopy, Rosen, C. A., Murry, T, eds. Otolaryngologic Clinics of North America Voice Disorders and Phonosurgery I 2000;33:751-757; Baken, R. J., Orlikoff, Robert F. Clinical Measurement of Speech and Voice, 2nd edition, San Diego: Singular Thomson Learning, 2000, pp 394-405, the contents of which are incorporated herein by reference.

The vocal folds are a paired structure located in the larynx, which sits below the base of the tongue, atop the windpipe in the throat. Voice is an acoustic wave produced by the transfer of energy from exhaled airflow to the layered mucosa of the vocal folds, resulting in passive nearly periodic vibratory movement. Rates of vibration range from 75 Hz up to greater than 1 KHz, depending upon gender and vocal pitch. Voice problems can result from factors that cause a periodic vibration and/or incomplete contact of the vocal folds during each cycle of vibration. Causative factors include non-cancerous and cancerous mucosal irregularities and diseases of the nervous system, lungs and other body systems. Visualization of the vocal folds at rest and during voicing is essential for diagnosis and treatment of voice disorders and laryngeal diseases.

The vocal folds are sensitive to touch in an awake individual. Therefore, during routine office examination, abnormalities within the vocal folds are typically inferred from imaging the surface structure and movement dynamics. Imaging challenges for achieving noninvasive, affordable instrumentation include the relatively awkward access to the vocal folds, their high rate of vibration and the need to record up to approximately 10 seconds of continuous imaging.

A current gold standard system for imaging the vocal cord is digital videostroboscopy. See Hirano, M., Bless, D. M., Videostroboscopic examination of the larynx, 1993; San Diego: Singular Publishing Group; Woo, P. Quantification of videostrobscopic findings—measurements of the normal glottal cycle. Laryngoscope 1996;106; Suppl. 79;1-20, the contents of which are incorporated herein by reference. Videostroboscopy uses noncoherent white light, pulse synchronized to vocal fold vibration, at a rate appropriate for progressive scan display, using a charge-coupled device (CCD) camera. Thus, it involves using a manually adjusted strobe to examine a patient's vocal cords. The typical resulting video image is an averaging of multiple vibratory cycles.

Videostroboscopic examination is not without its drawbacks. Significant limitations of stroboscopy are its dependence on periodic vocal fold vibration and poor correlation with the acoustic signal. Further, it is generally not possible to derive accurate estimates of anatomical dimensions due to the dependence of the size of the image on an unknown distance of the endoscope tip from the vocal folds. Clinical assessment is therefore generally dependent on subjective criteria. These weaknesses can limit the accuracy of diagnosis of disease, and impede advancement of our understanding of vocal physiology, which underlies the prevention, and treatment of voice disorders. Other commercially available, although less common, imaging techniques are high-speed video and videokymography. These can be unsatisfactory alternatives to videostroboscopy and the acceptable clinical application of these technologies has not been fully achieved. Thus, their use typically remains limited as a supplement to videostroboscopy.

High-speed photography or digital video is another alternative to stroboscopy. It has the advantage of imaging each cycle of vibration, rather than the stroboscopic intermittent imaging over a series of cycles. It is therefore independent of irregular vibration. Ultra-high speed photography using exposure rates in excess of 4000 frames per second (fps) was developed at Bell Telephone Laboratories See Farnsworth, D. W., High-speed motion pictures of the human vocal cords, Bell Telephone Laboratories Record 1940, 19:203-208, the contents of which are incorporated by reference. Film speeds up to 6000 fps have been achieved with the intense light required for ultra-short exposures. See Metz, D. E, Whitehead, R. L., Peterson, D. H., An optical-illumination system for high-speed laryngeal cinematography, Journal of the Acoustical Society of America 1980, 67:719-720, the contents of which are incorporated herein by reference. However, such ultra-high speed photography is also not always fully satisfactory. Disadvantages include camera noise, film speed jitter, and the difficulty of adapting the massive amount of film processing to automatic computer analysis, all of which lead to development of digital high-speed video.

Digital imaging has achieved frame rates in excess of 4000 fps but remains reliant upon CCD cameras and pixel resolution and the duration of recording typically does not exceed two seconds. See Eysholdt U, Tigge M, Wittenberg T, Proschel U., Direct evaluation of high-speed recordings of vocal fold vibrations, Folia Phoniatrica et Logopedica. 1995;48:163-170; Köster, O, Marx, B, Gemmar, P, Hess, M M, Künzel, H J., Qualitative and quantitative analysis of voice onset by means of a multidimensional voice analysis (MVAS) using high-speed imaging, Journal of Voice 1999, 13:355-374, the contents of which are incorporated herein by reference. Efficient processing of large amounts of raw data remains a challenge.

Videokymography (VKG) is based on the raster scan, such as that used by television technology. It scans a single line at rates up to and possibly over 8000 lines/second. See Schutte Hk, Ŝvec K G, Ŝram F, First results of clinical application of videokymography, Laryngoscope, 1998;108:1206-1210; Wittenberg T., Tigges M., Mergell P., Eysholdt U. Functional imaging of vocal fold vibration: digital multislice high-speed kymography, Journal of Voice 2000;14:422-442, the contents of which are incorporated herein by reference. Successive scan lines are displayed one beneath the next, with time advancing downward in the vertical dimension.

One VKG advantage is the display of each cycle of vibration. Therefore, it can be impervious to aperiodic vibration. However, a significant shortcoming of VKG is that slight movement of the larynx or the camera can shift the line being scanned, making interpretation of the image difficult. Further, it permits visualization of vocal fold movement at only a single line, limiting clinical application. VKG has been combined with stroboscopy to provide a more complete view of the vocal folds and to extract quantitative measures. See Qiu, Q., Schutte, H. K., Gu, L., Yu, Q., An automatic method to quantify the vibration properties of human vocal folds via videokymopgraphy, Folia Phoniatrica et Logopedica, 2003;55:128-136, the contents of which are incorporated herein by reference. However, the disadvantages of single line scanning and movement artifact remain.

In addition to needing accurate imaging of cycle-to-cycle vibration, an accurate measurement of dimension is desirable to provide objectivity to a currently subjective visual assessment. Stroboscopic or high-speed digital imaging depends on knowing the distance from the endoscope tip to the vocal folds. The feasibility of using a laser-based projection system based upon optical triangulation, in conjunction with stroboscopic image, for estimating dimensions has been established. See NIDCD/NIH 5R44DC004533-03 Rosen D (PI), Laryngeal endoscope with calibrated sizing function.), the contents of which are incorporated herein by reference. One such system remains reliant on stroboscopy for imaging vocal fold movement.

Some advances have been made in data processing, but cost-effective commercial processing remains limited. See Yan, Y., Analysis of vocal fold vibrations from high speed laryngeal images using a Hilbert-transformed based methodology, Yan, Y., Kartini, A., Kunduk, A., Bless, D., The Voice Foundation's 33rd Annual Symposium: Care of the Professional Voice, Philadelphia, Pa., Jun. 3, 2004, the contents of which are incorporated herein by reference. Currently, the only commercially available high speed digital video equipment known to be designed for clinical use offers grey scale imaging at 2000 frames per second. See Kay Elemetrics Corp., Lincoln Park, N.J., the contents of which are incorporated herein by reference. Continuous recording up to 10 seconds can be achieved, but the high frame rate limits spatial resolution to only 160×180 pixels. While this can allow correlation of a video image with acoustic output, the poor spatial resolution is generally insufficient for medical diagnostic purposes. Increased spatial resolution, often achieved by narrowing the observed field, has been achieved, but the costs remain prohibitive for routine clinical use. For this reason, its use is almost solely confined to research purposes.

Accordingly, it is desirable to overcome drawbacks in the prior art. The technology described in connection with the invention has the potential to improve the health of individuals with voice disorders by providing significant and novel information about the acoustic effects of abnormal vocal fold vibration. This knowledge, together with increased precision of imaging and ability to quantify vibratory behavior, has significant implications for increased accuracy of prevention, diagnosis and treatment of voice disorders. Thus, it is possible to overcome disadvantages of existing systems and methods.

### SUMMARY OF THE INVENTION

Generally speaking, in accordance with the invention, a high speed scanning system is provided which can image and provide diagnosis for objects moving in constrained locations. The system can be used to image engine parts, vocal cords, heart valves and the like. Systems in accordance with embodiments of the invention can involve the application of coherent beam technology to endoscopic examination to overcome existing imaging limitations and provide improved current clinical laryngeal imaging instrumentation. The invention can combine a laser beam system using an acousto-optic (or other) beam deflector and beam delivery optics with fast signal processing.

In accordance with the invention, a source of coherent light can be scanned over an object. The scanning can be controlled so that the position of the scanning beam is known at all times. Thus, reflected images of the object being scanned can be recorded at high speed and used to generate an image of the object. This image can be played back at a selected speed or frozen to provide still images. The image can be of its original dimensions, with little or no distortions caused by stray light, or specular reflections from adjacent areas, which can be the case in fast digital photography.

Systems in accordance with the invention can allow for vocal fold imaging at up to or exceeding approximately 700, preferably about 1000 frames per second with grayscale resolution as high as about 100 micrometers or higher and up to about a 10 mm, preferably 12.4 mm square or larger viewing area. This technological innovation can provide imaging of vocal fold vibration that correlates completely with a synchronously-acquired acoustic voice signal. This can enable physicians, voice therapists and research scientists to understand the consequences of abnormal laryngeal dynamics, rather than being limited to simply observing the dynamics. Further, the application of laser technology will allow for accurate measurements of dimension. This can objectify examination findings and treatment outcomes measurement, helping to overcome the serious limitations of current perceptual-based judgments.

Accordingly, the invention can provide a compact beam delivery system, which can overcome limiting image distortion due to wet tissue surfaces. The invention can also provide an effective clinical instrument system that can provide full color video imaging of vocal fold vibration and user-defined selection of breadth of viewing field and level of spatial resolution.

A laser endoscopy system in accordance with the invention can be based on a standard 70 degree rigid oral endoscope introduced into the oral cavity in the customary position using the video monitor for visual guidance in the standard examination method. Recording, storage and review of the examination can be controlled by the examiner. Systems in accordance with the invention can provide real-time imaging of vocal fold vibratory rates up to 0.7 kHz, preferably 1 kHz and higher, independent of periodicity and completely correlated with the synchronous audio waveform. Image clarity can provide excellent detail equivalent to the width of as small as a human hair (˜50 microns) of a 12×12 mm² area. The image can be provided in grayscale or in full color imaging.

Accordingly, it is an object of the invention to provide or improved system and method to for imaging vocal cord structure and diagnosing vocal cord disorders.

Still other objects and advantages of the invention will in part be obvious and will in part be apparent from the specification and drawings. The scope of the invention will be indicated in the claims.

### BRIEF DESCRIPTION OF THE DRAWINGS

For a fuller understanding of the invention, reference is had to the following description, taken in connection with the accompanying drawings, in which:

FIG. 1 is a block diagram of a laser scanner in accordance with one embodiment of the invention;

FIGS. 2A, 2B and 2C are graphs showing the change of voltage with time for signals involved in a scanning operation in accordance with one embodiment of the invention;

FIG. 3 is a schematic view of a laser scanner system in accordance with an embodiment of the invention;

FIG. 4 is a schematic side view of an acousto-optic deflector, used in accordance with an embodiment of the invention; and

FIG. 5 is a schematic view of a scanning system in accordance with an embodiment of the invention.

### DETAILED DESCRIPTION OF THE PREFERRED EMBODIMENTS

Systems in accordance with the invention can produce high quality still and moving images of moving structures in tight, hard to access locations. Though the primary application for systems in accordance with the invention is likely to involve generating images and methods of diagnosis relating to the vocal cords, the invention can find applications in other areas, such as imaging heart valves, engine systems and other applications.

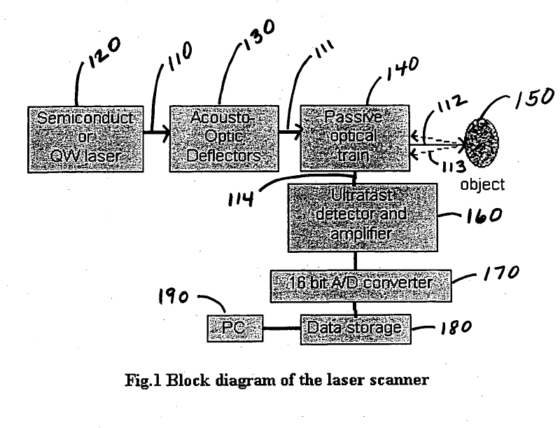

The core optical sub-system that enables generation of vocal fold imaging in accordance with an embodiment of the invention is a laser scanner. The laser scanner performance and capability relies in turn on several optoelectronic components. A functional block diagram of a vocal fold imaging laser scanner 100 assembled in accordance with an embodiment of the invention is shown in FIG. 1 to form image, a beam of coherent light 110 of a fixed wavelength (preferably selected from λ=700-1000 nm, preferably the 800-980 nm range) is output from a fixed wavelength semiconductor quantum well (QW) laser 120 light beam 110 is collimated and then directed onto a two-dimensional acousto-optic beam deflector (AOD) 130 and output as deflected as scanning beam 111. Beam deflector 130 can be set to operate in the raster scanning mode. Deflected beam 111 then passes through an optical train 140, which on the way to an object under image, focuses the beam to send a focused deflected beam 112 to the appropriate position in the object (e.g. vocal fold) plane. A beam of reflected (as well as the scattered) light from the object 113 is collimated back through optical train (e.g. an optimized passive optical train) 140 and guided as a reflected image beam 114 into a detector, such as an ultrafast detector arm and amplifier 160 by the use of additional optics.

The corresponding detector voltage (V_{d}) of detector 160 can be digitized as an imaging signal point component for a given scan x-y position thus representing an image signal level for each selected pixel. Because the beam path is actively controlled by acousto-optic deflector (AOD) voltages (Vₓ and V_{y}) the corresponding pixel position coordinate (x and y) is the direct function of AOD 130's instantaneous drive voltage values. Thus, the three voltage values (V_{d}, Vₓ, and V_{y}) are components of a Vᵢ vector value for the i-th image pixel. Sweeping the electronically deflected angle in both directions through n-number of discrete values and recording the corresponding signals from the detector can form a complete digital representation of an image (or frame) that will consist of 3n² digital points streamed through, e.g., a 16 bit A/D converter 170 to be received in e.g., a digital storage chip 180.

An appropriate (and fairly simple) software algorithm will sort the data points based on the x,y voltage values and reconfigure it into a standard image file format that can be viewed on a monitor of e.g. a PC 190. From the design details of a preferred embodiment of the invention, which will be outlined below, it follows that the characteristic frame update cycle can permit at least several dozens of frames to be acquired and stored within a typical cycle of the concurrently recorded sound waveform.

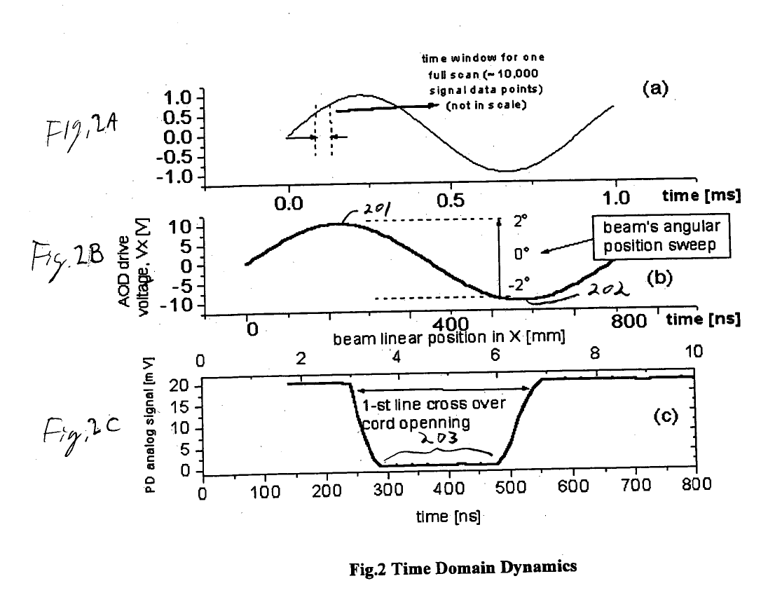

By way of non-limiting example to demonstrate simplistic time domain flow of signals and image formation within a sound cycle, corresponding simulated data shown in FIGS. 2A-2C were plotted.

Within a sound cycle, (FIG. 2A), multiple frames can be routinely acquired. The image line in one direction is formed by sweeping the AOD drive voltage with frequency of f_{sweep}˜50-100 MHz. The corresponding angular position of the beam typically changes within a few degrees (e.g. 2 to −2) from high peak 201 to low peak 202 within less than 500 ns (FIG. 2B) that results in a spatial coordinate change of ˜10 mm for a particular optical design which will be described below. If the object has a nonreflecting surface (like a vocal fold opening) within the beam's position sweep range it will result in absence or greatly reduced signal detected by the fast photodiode (See region 203 in FIG. 2C). This one line scan represents part of an image along one line and depicts a straight line cross over vocal cord opening. If the corresponding voltage (Vy) is applied in the other direction with a frequency of f_{sweep}/Nₚᵢₓₑₗₛ that will result in raster consisting of Nₚᵢₓₑₗ lines, thus producing a frame of continuously scanned positions within the scanning area.

Presented below are non-limiting exemplary design details and specifications for the key components to be used in the apparatus.

The optical components, specifications and layout for the laser scanner can be optimized in ray tracing simulations produced by varying several linear dimension parameters such as lenses' focal lengths, beam diameter at different points on the optical axis, limits dictated by the size of endoscope, etc.

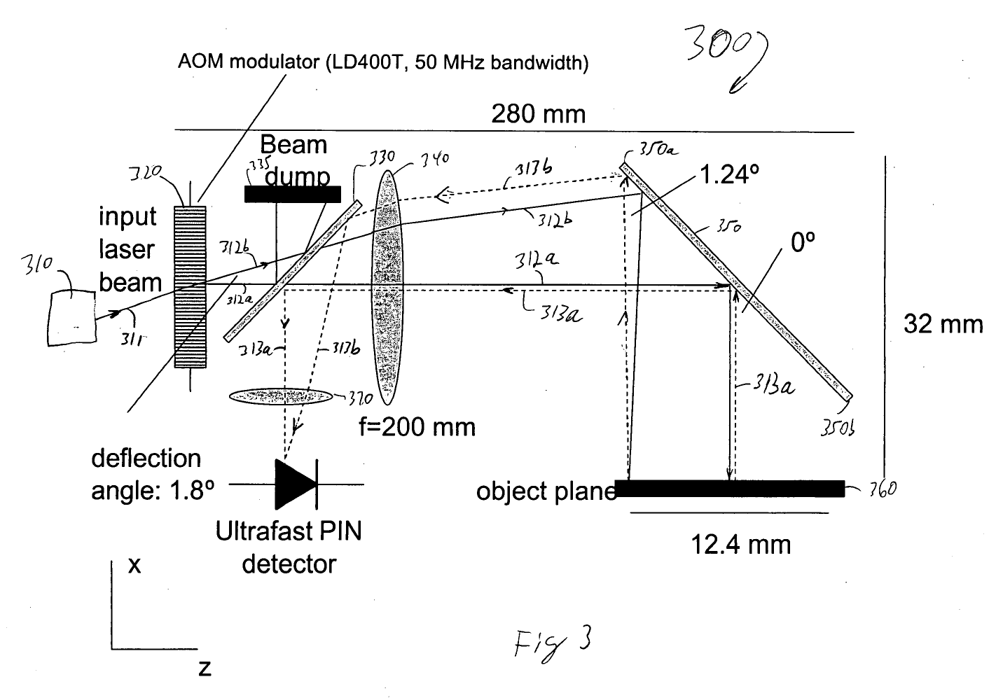

One preferred embodiment of the invention is shown schematically in FIG. 3 as laser beam scanner 300, with the indicated exemplary angular and linear dimensions and optics specifications. An optical train as shown in FIG. 3 can allow spatial resolution to be as good as 100 μm, preferably 35-40 μm or better (limited by the spot size of the focused output of the laser by a lens with ˜200 mm focal length) in the x-y plane with the corresponding Rayleigh length of 1.1 mm. The scanned area is 12.4×12.4 mm².

The scanning area limits due to the above mentioned overall dimensions of the endoscope may be overcome, to result in a significant increase in the active imaging area by incorporation a MEMS (micro electro mechanical switch) chip mirror or matrix into the design instead of the passive beam steering mirror. A MEMS mirror is capable of deforming (altering its angular position with respect to the incident beam) and guiding the beam after the lens into certain precise (and electronically controlled) locations within the vocal cords that cannot be reached by the previously described core system with the passive beam steering mirror.

The corresponding ray paths are shown in solid lines and the reflected beam paths are dashed. An input laser source beam 311 from an input laser beam source 310 is adjusted in diameter to provide optimum performance for the AOD. Beam source 310 can be a semiconductor diode laser source. Beam source 310 can be an approximately 100 mW range output power semiconductor QW laser. The power can be adjusted and maintained by an appropriate current bias value. The deflected beam is split by a 50/50 beamsplitter and focused by an f/16 lens (f=200 mm). The deflected beam is guided by a high reflector mirror set at a 45° angle at 175 mm distance from lens to the image plane. Part of the beam is reflected back, collimated with the lens, and then picked up by a beamsplitter. The beam is focused by another lens onto the ultrafast detector active area. With a beam diameter of 6 mm the full beam raster is confined to the cross-section area of 12.5×12.5 mm². The corresponding area diameter is set by the limit in the lateral dimension of the endoscope tube.

As shown in FIG. 3, a beam source 310, such as a semiconductor laser, outputs an input laser beam 311 to an AOM modulator 320. Of course, there are a large number of deflected beams 312b, but only one is depicted, for convenience. A preferred AOM modulator selectively deflects input beam 311 in a raster scan to output a scanning beam 312a without deflection and a deflected scanning beam 312b. One preferred AOM modulator is the LS-110-XY, available from Isomet Corp. of Springfield, Va., which has a 50 MHz bandwidth. Beams 312a and b pass through a one way mirror 330 to a collimating lens 340. A beam dump 335 is included to receive light scattered from mirror 330. Lens 340 preferably has a focal length (f) of 200 mm.

Scanning beams 312a and 312b are directed to a reflecting mirror 350, preferably at 45 degrees. In one embodiment of the invention, an end 350b of mirror 350 is 280 mm from AOM modulator 320. Mirror 350 directs beams 312a and 312b to a vibrating object plane 360. Object plane 360 can be 32 mm from a top end 350a of mirror 350. A vibration in object plane 360 less than 1 mm in the longitudinal direction should not alter the position of the deflected beam because it is within the depth of focus of the system, as discussed in the previous section on system design. Scanning beam 312a and 312b will be reflected as reflection beams 313a and 313b, respectively.

Pixel data acquisition and processing time can be less than 10 ns. This can be much faster than a typical period of an acoustic vibration, which is typically less than 1 ms. A voice waveform can be recorded simultaneous of with a microphone and can be digitized by appropriate circuitry.

Reflection beams 313a and 313b pass back through lens 340, and then are reflected off mirror 330, through a lens 370 to a light beam receiving collection area, having, e.g., an ultrafast PIN detector (broad area or CCD detector for the inverted image). A deflection angle of 1.8° is acceptable. A full deflector angle of 3.6° can help ensure that a 12.4 mm square is covered. The system can keep track of the location of the spot imaged by knowing the x-y voltage data for AOM modulator 329 and convert each pulse reflected off the object into an image spot (pixel). Thus, images of the vocal cords can be recorded as two-dimensional scans for acceptably long periods of time, such as at least 1, 5 or 12 or more seconds.

The incident power that will be incident on the vocal fold area typically can be maintained at below about the 20 mW, preferably the 10 mW level, which is far below the level that may cause any deleterious effect on the tissue due to absorption at the laser wavelength. Part of the power will be reflected back by the wet surface independent of the power absorbed by the tissue and its constituents, such as blood and water, and the absorption penetration depth. This can be the minimum reflected laser power from the tissue surface that will be detected by the detector in the image plane. This power should be proportional mostly to Fresnel reflection on the air/water interface (index of refraction change of 1.33107), resulting in a value of approximately 2% of the incident power. Additional optical design configurations, passive optical components (lenses and mirrors) of different design and parameters can be employed.

Laser Source Specifications.

The light source can be commercially available. In one embodiment of the invention, the light source can be a small form factor (14-pin butterfly package) uncooled semiconductor quantum well laser. Acceptable lasers are able to deliver up to several hundred milliwatts of fiber coupled (SMF) power at a selected wavelength. This is advantageously in the wavelength output range of about 780-1060 nm. Typical laser characteristics show excellent wavelength stability over lifetime (e.g., +/−0.2 nm), narrow line width (e.g., ˜50 MHz), low relative intensity noise (e.g., ˜140 dB/Hz), stable lowest order TEMOO mode and power. The overall electric power consumption of the module should not exceed 1.5 W (end of life). Depending on the packaging configuration, the laser output can be collimated by an external lens or by a lens in the package, in which case the fiber is removed. The output beam shall be linearly polarized. As an option a λ/4 plate can be introduced to assess the polarization aspects of the signal reflected from the object surface.

The use of a single wavelength laser represents a simple embodiment of the imaging system and provides a high frame rate. For full color imaging, a laser source with e.g., three differently colored beams corresponding, e.g., to the three primary colors, red, green, blue or cyan, magenta, yellow could be employed. In this case the frame rate could be reduced by a factor of at least three, because of the time needed to switch between the three wavelengths and to acquire the data at each of the wavelengths.

Acousto-Optic Deflector.

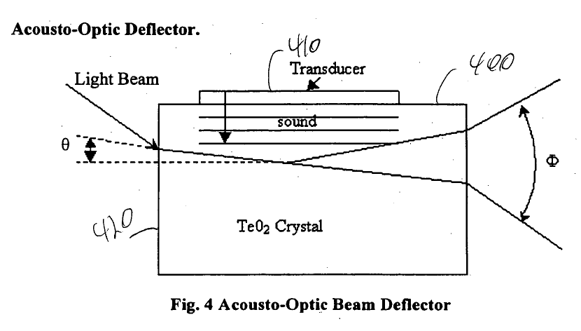

As shown in FIG. 4, an acousto-optic deflector 400 can comprise a flat, thickness mode piezoelectric transducer 410 bonded to an acousto-optic crystal 420, such as a TeO₂ crystal. Acousto-Optic deflectors are discussed in “Acousto-Optics” by J. Sapriel, pp. 70-83, John Wiley & Sons, New York (1976), the contents of which are incorporated herein by reference. An electrical signal applied to transducer 410, produces acoustic waves that propagate into crystal 420, producing an index of refraction grating. Light rays passing through crystal 420 are diffracted by the phase grating according to Bragg's Law, such that the Bragg angle θ is given by
sin θ=λ₀/2nΛ (1)
where λ₀=light wavelength in air, Λ=acoustic wavelength and n=index of refraction of the crystal. The total angular spread, Δ_{φ}, obtainable in an A-O deflector across its bandwidth Δ_{f} is
Δ_{φ}=λ₀Δ_{f}/v (2)
where v=velocity of sound in the crystal (e.g., Te0₂). By essentially placing two crystal modulators, back-to-back, at right angles, a two-dimensional scanning modulator can be provided.

A commercially available X-Y acousto-optic deflector, which can be used in the scanner, is based on TeO₂ crystals that have low absorption in the visible and near-infrared. With a resonant acoustic wavelength in the range of up to GHz and modulator bandwidths as high as 200 MHz, the full angle of deflection can be as large as 5° in the near IR range of optical wavelengths. The corresponding resolution routinely yields in 500×500 angular spots within the full scan angle area with access time as short as few μs. In the scanning mode spot-to-spot transition times are typically less than 5 ns allowing full scan for standard 100×100 angular spots (that will correspond to data points separated by ˜100 μm for our optical design) to be accomplished in <50 μs, which corresponds to a rate of 20,000 frames/s. Thus, the deflector switching speed limit in scanning a 12×12 mm² area with typical resolution of <40 μm and data points spatially separated by ˜100 μm falls in the range when multiple updates of the area's image within the highest frequency cycle (˜1 kHz) of sound wave produced by vocal folds are feasible. An optical efficiency of 50% or higher for the deflected beam can be achieved when several watts of drive power is applied.

Ultrafast Detector.

In the spot-by-spot scanning a high bandwidth (Δf_{3dB}=2.5 GHz) p-i-n detector can be used to record the reflected image. Acceptable detectors are discussed in Fast p-i-n Detectors: Wey, Y. G. et al. “110 GHz InGaAs/InP Double Heterostructure p-i-n Photodetectors, IEEE Journal of Lightwave Technology Vol. 13, 1490 (1995), the contents of which are incorporated herein by reference. The typical responsivity for the detector should be better than 0.8 A/W. The corresponding sensitivity level should be less than 5 μW, saturation power >1 mW. The absolute ripple figure should be less than 0.75 dB, and dark current should be less than 10 nA. The detector can be housed in a small package including standard 14-pin butterfly design with fiber pigtail. Overall electric power consumption of the detector module can be less than 0.2 W. Fast Avalanche Photodiodes, are discussed in Campbell, J. C. et al, “Recent Advances in Avalanche Photodiodes”, IEEE Journal of Selected Topics in Quantum Electronics”, Vol. 10, 777 (2004), the contents of which are incorporated herein by reference. See also, Susan, S. Photodetectors, “Photonic Devices and Systems” (ed. Robert G. Hunsperger), pages 171-246, (1994), New York Marcel Dekker, the contents of which are incorporated herein by reference.

In order to estimate the available signal levels from the detector, one can consider 10 mW laser power incident on the object. It can further be assumed that approximately 4% of the power is reflected due to linear reflection from the air-wet surface interface in the object plane, and an additional loss of 50% for the reflected signal is introduced by the beamsplitter. Given the detector responsivity, current levels for the signal on the order of 0.2 mA can be experienced, which gives four orders of magnitude in the available linear dynamic range for the signal change. Using a 100 MHz bandwidth electronic circuit with 20 dB gain, it should be routine to amplify the signal to approximately the 1V level (0.2 mA×50 Ohm×100). This can be then be digitized with high resolution that can result in up to several hundred digital counts (for 12-bit resolution A/D converter), thus determining the number of grayscale image tones.

Acquisition, Processing and Storage Electronics.

Fast digital data acquisition, processing and storage can be achieved with commercially available off-the-shelf, high-speed digitizers with PC connection through a PCI slot. Preferred equipment will support the ultimate scanning speed offered by the laser scanner hardware apart from signal detection part (i.e. >20,000 frames/sec).

High-speed digitizers, also known as PC-based oscilloscopes, offer at the same time, several advantages over the traditional stand-alone oscilloscopes. This advantage is achieved by using an open architecture and flexible software. Commercially available digitizers can have a resolution ranging from 8 to 21 bits with low-jitter clocks that improve measurement accuracy and stability. In addition, high-speed digitizers have advanced timing and synchronization hardware. This allows integration with other instrumentation functions, such as arbitrary waveform generation, digital I/O, and image acquisition.

Listed below are the summary characteristics of an example of the specific product in accordance with one embodiment of the invention.

| | |
|---|---|
| Bit resolution: | 16 |
| Analog signal bandwidth (3dB): | 100 MHz (or 3 ns in signal rise-time) |
| Real-time sampling rate: | 100 MS/s |
| Memory storage capacity: | 32 Mb |
| Double buffer data stream rate: | 40 Mb/s |

The boards can be enhanced with commercially-developed software that offers a variety of built-in measurements. These include waveform math, time and voltage histogram measurements, and frequency measurement tools (e.g. digital filters, etc.) and FFT spectrum analysis. In addition, a variety of waveform math operations can be performed, including integration and polynomial interpolation. Additional information can be extracted from the acquired waveform automatically without performing post-processing of the signal.

Data Collection, Analysis and Interpretation.

As discussed above, data corresponding to sequence of image frames can be stored in an electronic digital storage device (commercially available). The data can consist of a three column matrix of digital voltage values corresponding to AOD drive voltages (Vx, Vy) and detector voltage (Vd). The first two values are straightforwardly converted into corresponding pixel spatial coordinate values given the relations between the applied drive voltage and the deflected angle and geometrical parameters of the optical layout. One standard (100×100 pixel) frame will occupy approximately 30 kB digital space. For a sound waveform lasting a few seconds, up to ˜10,000 frames can be collected sequentially. This can bring the total digital data volume for the measurement cycle to 300 Mb. After the measurement, the data are streamed into a PC where they can be reformatted to a standard image file and viewed on a monitor. As it follows from the previous discussion, each frame will carry a time marker tightly bounded to a specific moment of time within the sound waveform. The data processing interface program can sort the frames and save those which are selected for particular interest.

Scanning systems and method in accordance with the invention can have intrinsic advantages over existing fast digital photography and/or stroboscopy techniques used in current imaging devices based at least on the following:
Consistent accurate synchronization to acoustic wave (voice) irrespective of cycle-to-cycle irregularities
Multiple image acquisition capability.
Accurate dimension measurements.
High spatial resolution, which is free of contributions that negatively affect point spread function in white light source, based imaging technique (chromatic aberrations, specular reflections and different type of light scatterings, etc.).
Absence of high voltage electronics that is needed to drive xenon lamp in stroboscopy-type of measurements.
Order of magnitude less power consumption.
Higher reliability of the scanner over lifetime.
The scanner equipment (except PC) can be packaged into a small suitcase, which makes it easily portable.

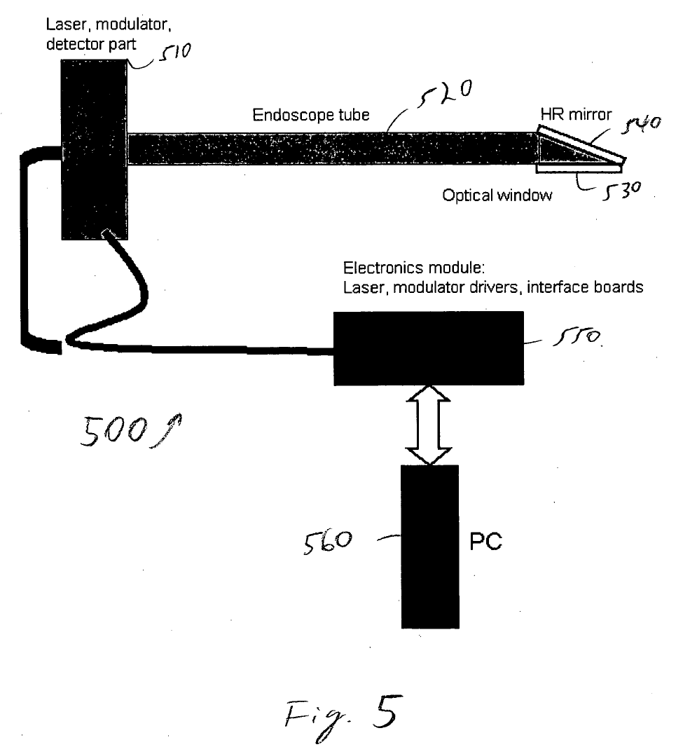

An example of a system for imaging vocal cord folds and vibration is shown generally as Imaging Device 500, in FIG. 5. Device 500 includes a beam generator/receiver 510, which includes a laser source, a modulator and a detector to receiving and recording reflected images. A laser beam from generator/receiver 510 is connected to an endoscopic tube 520 for extending an optical beam 530 into a patient's throat, where beam erges, after being reflected from an HR mirror 540.

After the beam reflects off the vocal cords, it reflects off HR mirror 540, back to the detector portion of beam generator/detector 510, where a signal is generated and sent to an electronics module 550. Module 550 includes a controller for activating the laser and driving the AOM modulator. It can also include interface boards for communicating with a PC 560 where the image can be recorded.

It is also to be understood that the following claims are intended to cover all of the generic and specific feature of the invention herein described and all statements of the scope of the invention, which, as a matter of language, might be said to fall there between.

What is claimed is:

1. A vocal cord imaging device, comprising:
a beam detector constructed to record an image when light reflected off an object is received thereon;
a light source constructed to generate a beam of coherent light;
an acoustic optic deflector responsive to a control signal, the deflector constructed to receive and convert the beam into a scanning beam, controlled by the control signal;
an optical train constructed to direct a scanning beam from the deflector to an object and to receive and direct a beam reflected off the object to the beam detector.

2. The imaging device of claim 1, wherein the beam detector is constructed to generate a signal corresponding to the recorded image and a computer is coupled to the beam detector, the computer constructed to receive the signal from the beam detector and generate an image based on the signal received from the beam detector.

3. The imaging device of claim 1, wherein at least a portion of the optical train is part of a probe, sized and shaped to be inserted into a human mouth in a position to shine the beam on the vocal cords.

4. The imaging device of claim 3, wherein the probe is designed to received a beam reflected off the vocal cords and direct that reflected beam towards the beam detector.

5. The imaging device of claim 1, wherein the light source is constructed to generate a laser beam.

6. The imaging device of claim 3, wherein a signal processor is coupled to the beam detector and the signal processor is constructed to general a frame-sized image generating device, such that vibrating vocal cords can be imaged at over about 700 frames per second.

7. The imaging device of claim 6, wherein the image generating device can be used to image at least a 10 mm² area of the vocal cords.

8. The imaging device of claim 2, wherein the device is capable of generating full color images of vibrating human vocal cords.

9. The imaging device of claim 1, wherein the device is constructed to output a scanning beam with a wavelength of about 700-1100 nm.

10. The imaging device of claim 1, wherein the device is constructed to output a scanning beam with a wavelength of about 800-980 nm.

11. The imaging device of claim 1, wherein the light source comprises a semi-conductor laser.

12. The imaging device of claim 1, wherein the light source comprises a semiconductor quantum well laser.

13. The imaging device of claim 1, wherein the deflector is constructed to scan in the raster scanning mode.

14. The imaging device of claim 5, wherein the device is constructed such that the power of the beam to be directed onto the vocal cords is about 20 mw or less.

15. The imaging device of claim 5, wherein the device is constructed such that the power of the beam to be directed onto the vocal cords is about 10 mw or less.

16. The imaging device of claim 1, wherein the light source comprises a laser constructed to output a beam in the range of about 780 to 1060 nm.

17. The imaging device of claim 1, wherein the deflector comprises piezoelectric material.

18. The imaging device of claim 1, wherein the deflector comprises a TeO₂ crystal.

19. The imaging device of claim 1, wherein the detector has a responsivity of at least about 0.8 A/W.

20. The imaging device of claim 1, wherein the light source produces at least three beams, each of a different color.

21. The imaging device of claim 2, wherein the light source beam detector and the computer are constructed to produce a full color image of the object.

22. An imaging device, comprising:
a beam detector constructed to record an image received thereon;
a laser source constructed to generate a laser beam;
a controllable light deflector, response to a control signal, the deflector constructed to convert the laser beam into a scanning beam, controlled by and responsive to the control signal;
an optical train constructed to direct a scanning beam from the deflector to an object and to direct a beam reflected off the object to the beam detector.

23. A method of imaging the vocal cords, comprising generating a scanning beam of coherent light; controlling the scanning beam with a scanning signal; reflecting the beam off the vocal cords to create an image pixel; storing the pixels of the reflected light and associating the pixels with the known values of the scanning signal; assembling the stored image to create one image frame.

24. The method of claim 23, comprising generating at least 700 frames per second.

25. The method of claim 23, wherein the method includes directing the beam onto the vocal cords of an individual in need of diagnosis of a speech condition and formulating a diagnosis based on the information depicted in the image frames.

26. The method of claim 23, including using the information depicted in the image frames to measure vocal cord structures.

27. The method of claim 23, including recording the voice waveform simultaneously with the image frames.

28. The method of claim 23, including generating multiple scanning beams of different colors.

29. The method of claim 23, wherein the image frames are color images.
